(19) United States
(12) Patent Application Publication
(10) Pub. No.: US 2009/0114822 A1
(43) Pub. Date: May 7, 2009

(54) TERAHERTZ DISPERSIVE SPECTROMETER SYSTEM

(75) Inventors: James A. Cox, New Brighton, MN (US); Bernard S. Fritz, Eagan, MN (US); Fouad Nusseibeh, Champlin, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/935,917

(22) Filed: Nov. 6, 2007

(51) Int. Cl. G01J 5/02

(52) U.S. Cl. 250/341.1

(57) ABSTRACT

A spectrometer system for providing information about a target with terahertz radiation. The system may receive incident radiation from the target through fore optics, a slit aperture, secondary optics and a dispersive element which images a slit on an array of terahertz sensitive detectors. The detectors may include uncooled sensors. Each sensor may be connected to its own micro antenna. The array of detectors may be situated proximate to the dispersive element so that radiation from the element may be dispersed according to wavelength to the respective detectors optimally sensitive to the various respective wavelengths. Detector signals indicating the impingement of terahertz radiation may provide information for identifying a material of the target.

### BACKGROUND

The present invention pertains to sensors and particularly to spectrometers. More particularly, the invention pertains to terahertz spectrometers.

### SUMMARY

The invention is a dispersive spectrometer system incorporating terahertz sensitive uncooled sensors.

### BRIEF DESCRIPTION OF THE DRAWING

FIG. 1 is a diagram of an overall layout of the present spectrometer system;

FIGS. 2a-2f are graphs of spectra of various materials;

FIG. 3 is a diagram of a spectrometer with refractive optics;

FIG. 4 is a diagram of a spectrometer with reflective optics;

FIG. 5 is a diagram of an array of detectors of the present system;

FIG. 6 is a diagram of a terahertz detector;

FIG. 7 is a graph of an example bandwidth for a micro-antenna of the terahertz detector;

FIG. 8 is a cross-section view of a MEMS thermal electric micro-bridge sensor;

FIG. 9 is a graph of noise equivalent power versus thermal conductance of an uncooled thermoelectric microbridge sensor; and

FIGS. 10a, 10b and 10c are diagrams of several micro-antennas that may be used in the present terahertz detector.

### DESCRIPTION

Terahertz (THz) spectroscopy may be useful for identifying gases (rotational bands and rotation-vibrational bands) and solids (lattice vibrations). Spectroscopy techniques at THz frequencies may rely on Fourier transform methods (e.g., Michelson or laminar grating spectrometers), time domain spectroscopy (another Fourier transform method), or tunable, narrowband sources.

The system of the present invention may be a dispersive slit-based spectrometer using a linear array of uncooled, microbridge detectors, each coupled to its own micro-antenna. The linear array of detectors sensitive at THz frequencies may be integrated into a dispersive slit-based spectrometer having fore-optics, slit aperture, secondary optics, and a dispersive element which reimages the slit onto a detector array. The array of detectors may be designed to have optimum sensitivity in the spectral range of interest defined by the dispersive range of the element. The array may be THz sensitive and uncooled. The array of uncooled THz-sensitive detectors may be used to collect the THz radiation in each spectral bin (sub-band). The system may use the convention that terahertz (THz) radiation includes frequencies of the electromagnetic spectrum typically between 0.1 THz and 10 THz.

A dispersive spectrometer may be realized in several forms using refractive or reflective optics, and one or more of various types of dispersive elements. The dispersive spectrometer may use arrays of detectors (either 1D or 2D) to realize a multiplexing advantage (i.e., the energy in each spectral band may be sampled during the time the spectrum is acquired).

Patent applications owned by the same assignee of the present application may be referred to for additional spectroscopic information. The applications may include U.S. patent application Ser. No. 11/350,541, filed Feb. 9, 2006, and U.S. patent application Ser. No. 11/446,806, filed Jun. 2, 2006. U.S. patent application Ser. No. 11/350,541, filed Feb. 9, 2006, and U.S. patent application Ser. No. 11/446,806, filed Jun. 2, 2006, are hereby incorporated by reference.

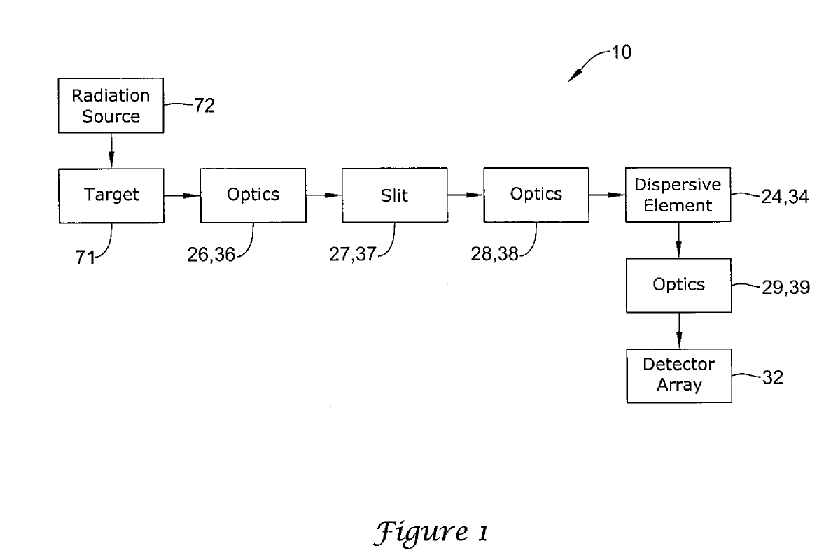

FIG. 1 is a diagram of an overall layout of the present spectrometer system 10. There may be a target 71 having a material of interest. Target 71 may be impinged with terahertz radiation from a source 72. Spectrometer system 10 may work with virtually any THz source. Target 71 may reflect or emanate radiation, such as light, which includes components having terahertz frequencies. The radiation may go through optics 26, 36. Optics 26, 36 may focus the radiation onto a slit 27, 37. Radiation going through slit 27, 37 may go through optics 28, 38 which collates the radiation. The collated radiation may go to a dispersive element 24, 34. Element 24, 34 may disperse the radiation according to wavelength. Dispersed radiation from element 24, 34 may be focused by optics 29, 39 onto a detector array 32. The optics may refractive or reflective or a combination of refraction and reflection. There may be other forms of radiation conveyance and control.

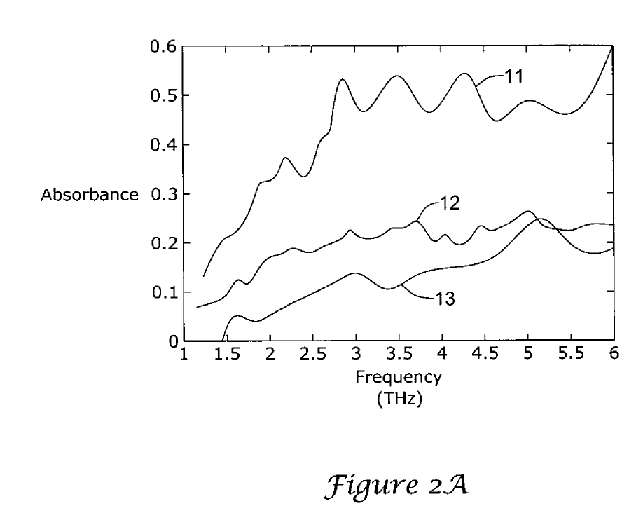

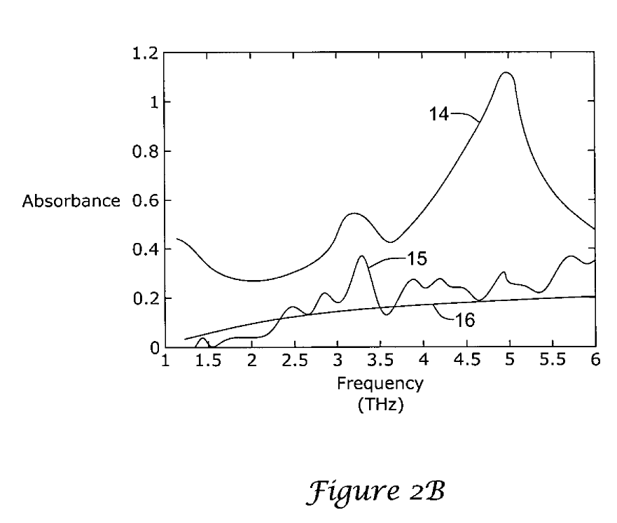

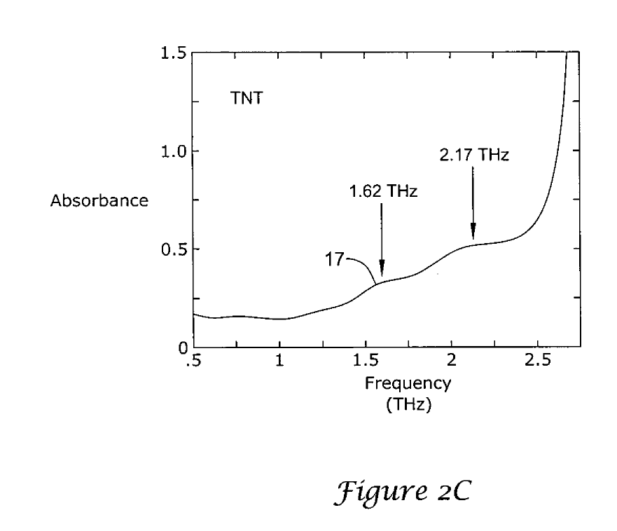

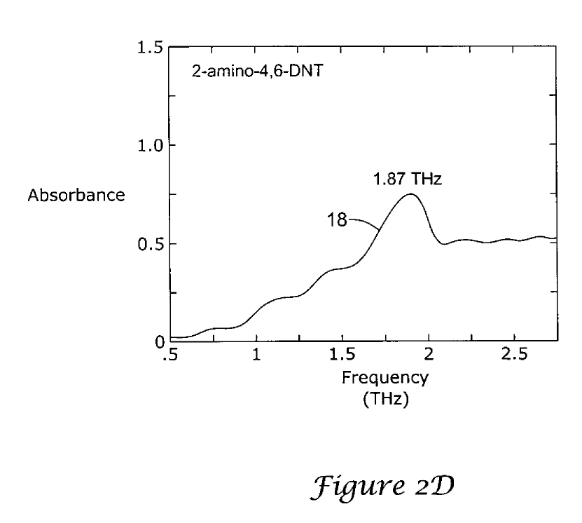

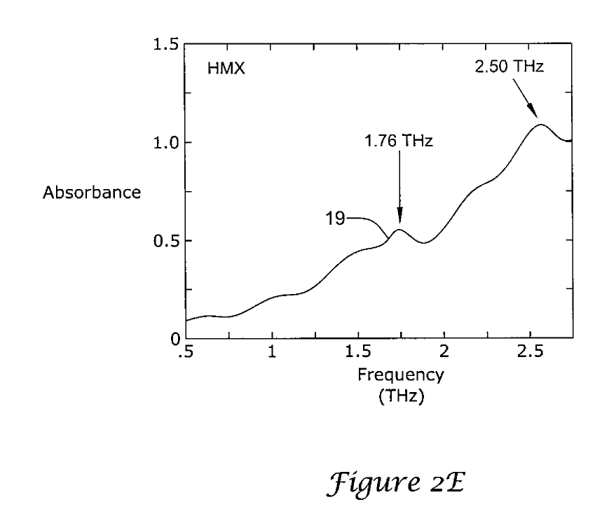

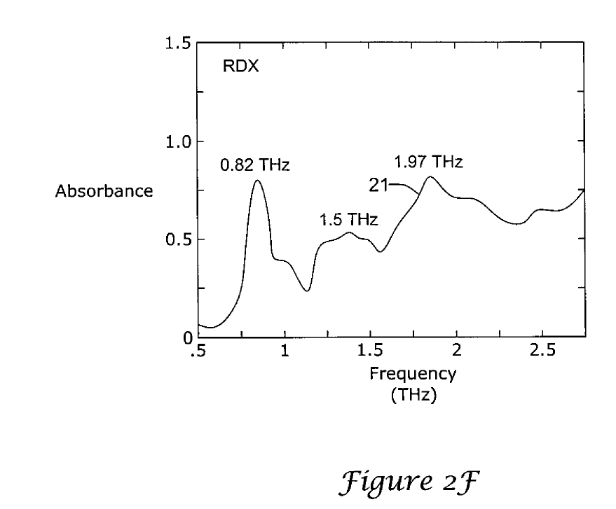

The following figures show an application of the invention. FIGS. 2a-2f illustrate spectral features in a number of crystalline or polycrystalline materials which may be detected with the present system. Rotational bands and rotational-vibrational bands of gases may exhibit spectral features at THz wavelengths. Spectra features may be regarded as rich “fingerprint” features enabling identification of various materials. FIG. 2a shows a graph of absorbance versus frequency (THz) which reveals distinct curves 11, 12 and 13 of pharmaceuticals such as Tylenol™, aspirin and Aleve™, respectively. FIG. 2b shows a graph of absorbance versus frequency (THz) which has curves 14, 15 and 16 of background material such as caffeine, lactose and salt, respectively.

FIGS. 2c-2f reveal an application of the present spectrometer system with absorbance versus frequency curves 17, 18, 19 and 21, respectively, for explosive-related compounds. Identification of these compounds with the curves may impel a critical application of the present system. Frequency peaks of the curves may provide an identification of the compounds. For instance, frequency peaks 1.62 THz and 2.17 THz of curve 17 may be an identification of TNT. Curve 18 has a significant 1.87 THz peak which may be indicative of a 2-amino-4,6-DNT material. Peaks of 1.76 THz and 2.50 THz of curve 19 may indicate HMX. RDX may be identified by 0.82 THz, 1.5 THz and 1.97 THz peaks of curve 21.

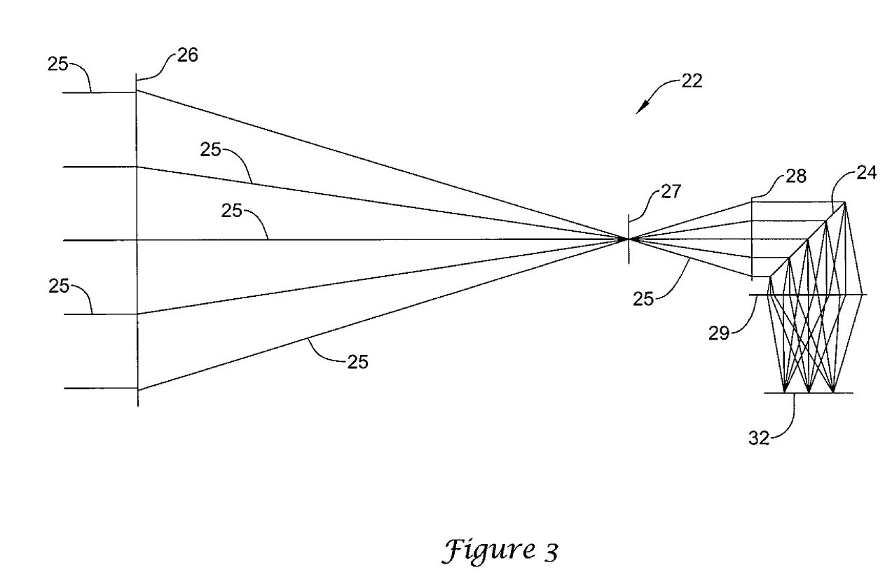

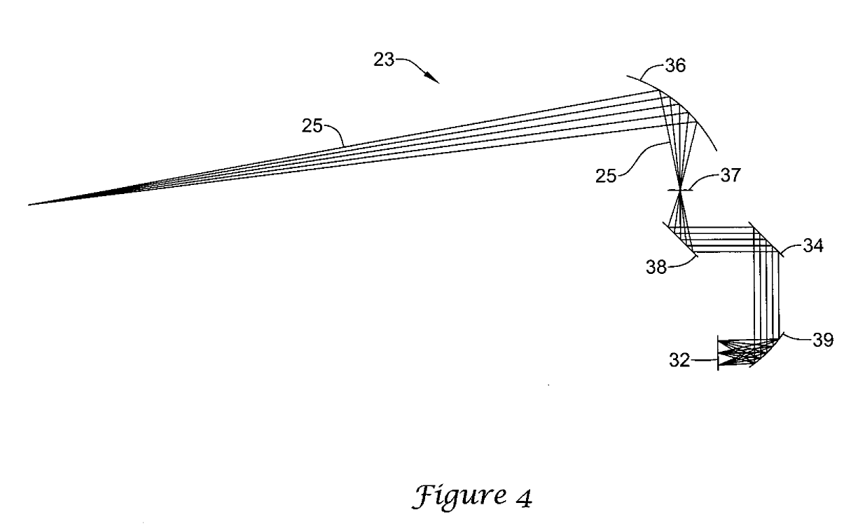

FIGS. 3 and 4 are diagrams of two implementations 22 and 23 of a THz spectrometer having refractive optics and reflective optics, respectively. Radiation 25 being reflected or emitted by a material may be captured by the refractive spectrograph 22. Radiation 25 may be a focused by a fore optic 26 through a slit 27 and onto a collimating lens 28. Collimated radiation 25 from lens 28 may impinge a transmissive dispersive element 24. Dispersive element 24 may be a grating, a prism or a grism (i.e., a combined grating and prism). The dispersive element may instead be reflective. Radiation 25 may be dispersed at different angles from the element 24 according to wavelength of the radiation. The dispersed radiation may be focused by a lens 29 onto a THz detector array 32.

Radiation 25 being reflected or emitted by a material may be captured by the reflective spectrograph 23. Radiation 25 may be a reflected by an ellipsoid reflective element 36 (viz., a fore optic) and focused through a slit 37 and onto a collimating reflective element 38. The collimated radiation 25 may impinge a reflective dispersive element 34. Dispersive element 34 may be a grating, prism or grism. The dispersive element may instead be transmissive. Radiation 25 may be dispersed at different angles from the element 34 according to wavelength of the radiation. The dispersed radiation may be focused by a paraboloid reflector 39 onto the THz detector array 32.

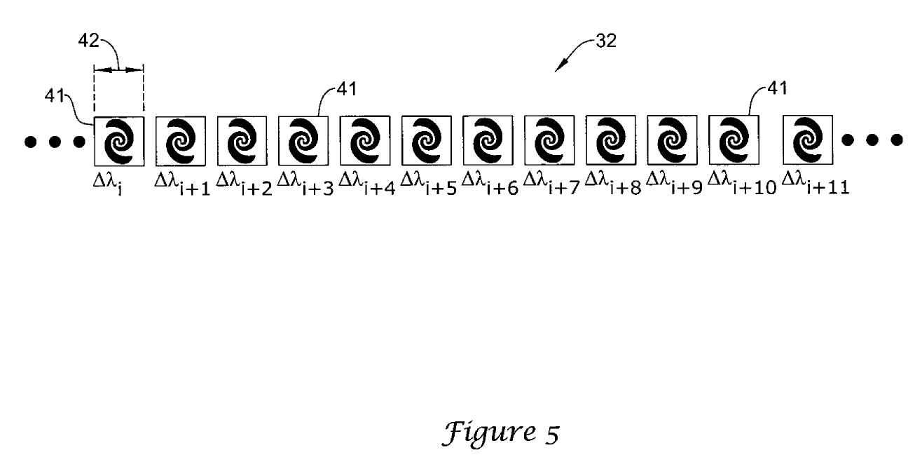

The detector array 32 may include a linear array of uncooled THz radiation sensitive detectors 41 specific to the present dispersive spectrograph system 22, 23. FIG. 5 is a diagram of array 32 of detectors 41. The spectral sensitivity, including gain and efficiency, of the detectors 41 or subgroups of them, may be adjusted by varying the design of the respective micro antennas of the detectors 41. The detector width 42 may be determined by the wavelength and a size of the image of the slit 27, 37 at the focal plane of the detector 41. The wavelengths for respective detectors 41 may be Δλᵢ, Δλᵢ₊₁, Δλᵢ₊₂, . . . . Each of these detectors 41 may indicate a given intensity THz signal of the image impinging it. The number of detectors 41 in the array 32 may be determined by the bandwidth desired of the spectrometer.

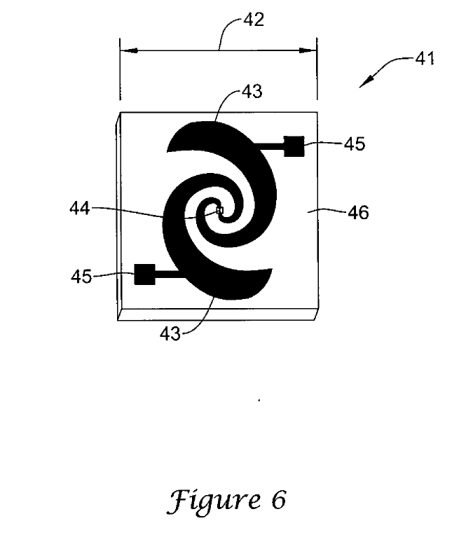

FIG. 6 is a diagram of design details of a THz detector 41. The detector may have micro-antenna elements 43 to collect incident THz radiation. A thermally isolated micro-bridge sensor element 44 may be situated at a central juncture at a gap between antenna element ends. The micro-bridge element 44 may bridge the gap. Element 44 may be, for example, a TE MEMS micro-bridge. Element 44 may convert the collected THz radiation into an electrical signal. The electrical signal may be read out at pads 45 of each detector 41. Antenna elements 43, along with pads 45, and sensor element 44 may be situated or formed on a membrane 46.

A dimension of length or width 42, which may be of either edge as detector 41 can be square in overall configuration. Alternatively, the overall configuration and/or outside dimensions may have a geometrical shape different than those as shown in FIGS. 5 and 6. The micro-bridge sensor 44 may be one of several types. Various types of sensors 44 may include those of bolometric, thermoelectric, pyroelectric, ferroelectric, and the like.

The dimension of the length or width 42 of detector 41 may be determined by the spectral band of the radiation that detector 41 is to sense. The dimensions 42 may be in a range of microns, depending on detected frequencies.

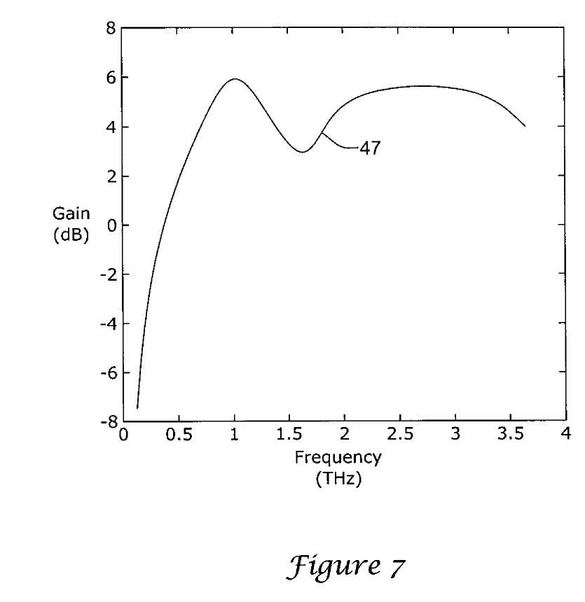

FIG. 7 shows a graph of an example of bandwidth for a micro-antenna 43 of detector 41. The graph shows a curve 47 of gain (dB) versus frequency (THz) which may represent a micro-antenna gain spectrum for a particular detector 41 having certain dimensions 42, antenna 43 type, sensor 44, and various design parameters.

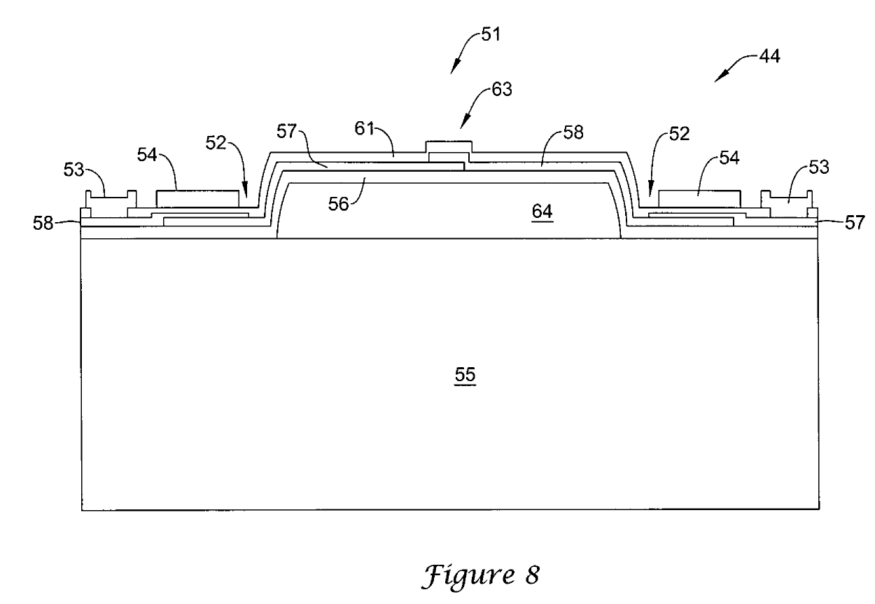

One of the features of the detector 41 of the present invention, which permits it to achieve very high sensitivity without requiring cooling, may include a very significant amount of thermal isolation provided between the collection of the radiation (via the micro antenna 43) and the detection of the radiation (via the microstructure 44). FIG. 8 shows a cross-section view of the TE MEMS micro-bridge sensor element 44. This view shows a “hot” thermoelectric (TE) junction 63, “cold” TE junctions 52, TE readout points 53, and antenna contacts 54. The components may be fabricated with micro electro mechanical systems (MEMS) technology situated on a substrate 55. The antenna coupling may be capacitive, resistive, or a combination thereof. The micro-bridge element 44 dimensions may be about 50×1×0.2 microns.

The microstructure 44 may have a microbridge 51 suspended over a substrate 55. Microbridge 51 may have a thermocouple 63 situated in the middle. A dielectric layer 56, such as silicon nitride, may be suspended over the substrate 55 by removal of a sacrificial layer in volume 64, and formed to provide the general shape of the microbridge 51. A layer 57 of a first metal, such as nickel iron (NiFe), may be deposited on top of the silicon nitride 56 extending from the mid-portion of the microbridge 51 towards the vicinity of the first antenna contact pad 54 on the left. A layer 58 of a second metal, such as chrome, may be deposited on top of the silicon nitride layer 56 extending from the mid-portion of the microbridge 51 towards the vicinity towards the vicinity of the second antenna contact pad 54 on the right. In the middle of the microbridge, the NiFe layer 57 and the chrome layer 58 may overlap for a short distance. Another dielectric layer 61 may be formed on top of the microbridge 51. The overlapping layers of the two metals (NiFe and chrome) may form a hot thermoelectric (TE) junction 63 of a thermocouple. Cold junctions 52 of the thermocouple may be positioned on the substrate at the ends of the NiFe and chrome layers. At the end of the chrome layer 58, there may be junction 52 by an overlapping NiFe layer 57. At the end of the NiFe layer 57, there may be another junction 52 by an overlapping chrome layer 58. NiFe and chrome are example materials. Other suitable materials may be used for the hot and cold junctions. Certain properties of the two materials may be selected relative to each other so as to optimize sensor performance. Some properties of interest may include electrical resistivity, thermal conductivity, and the Seebeck coefficient.

The currents caused to appear in the antenna 43 of detector 41 by incident radiation in its detection bandwidth may be coupled to the microbridge 51 of sensor element 44. The current in the microbridge 51 may generate heat in the junction 63. The heat may generate a voltage differential between the hot TE junction 63 on the microbridge and a cold TE junction 52 on the substrate at the foot of the microbridge 51. A voltage differential may appear at the contact pads 53 to which the read-out electronics can be coupled. The electronics may be on the same die as the micro antenna and microstructure. Alternatively, the readout electronics may be embodied on a separate die.

The antenna contact pads 54 may have a coupling mechanism between the micro antenna and the microstructure, and the thermocouple may have a “temperature signal detector”. The microbridge 51 as a whole may essentially include the hot 63 and the cold 52 TE junctions. The microstructure 44 may include the silicon nitride layer 56 which is suspended above the substrate and upon which the metal layers 57 and 58 and hot thermocouple junction 63 are supported.

The thermocouple 63, e.g., a temperature signal detector, may be well thermally isolated from the substrate 55 and the outside world by virtue of being in the middle of the microbridge 51 and most distant as practical from the substrate 55. Accordingly, much of the heat generated in the microbridge 51 may go to raising the temperature of the NiFe 57 and chrome 58 layers and will not be lost in the substrate 55. While the thermocouple 63 may be in ohmic contact with substrate 55, thermal conductance between microbridge 51 and substrate 55 is de minimis.

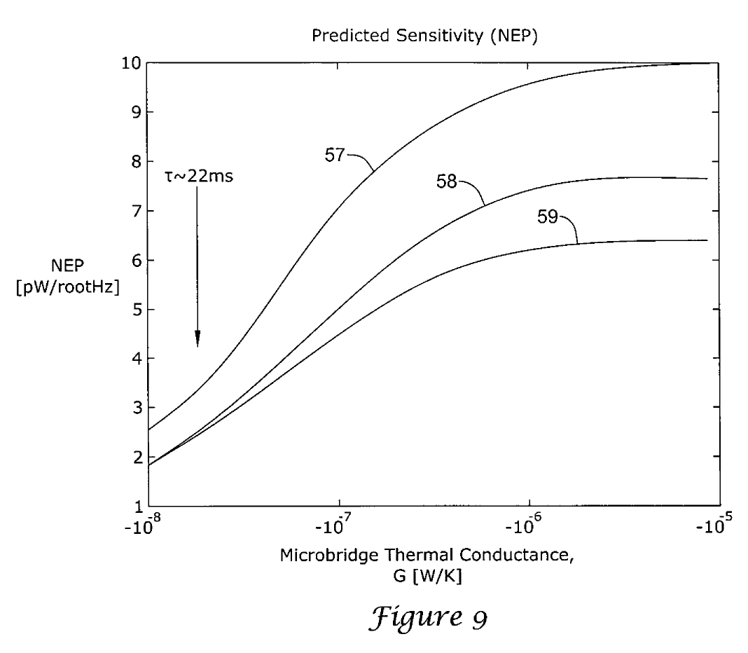

FIG. 9 illustrates sensitivity in terms of noise equivalent power (NEP) for a typical uncooled THz thermoelectric detector 41 with typical readout electronics. The Figure shows a graph of NEP (sensitivity in pW/root Hz) versus micro-bridge thermal conductance, G (W/K). Curve 57 reveals the total sensitivity of the detector 41 and associated electronics. The time constant τ (tau) of the response may be noted to be about 22 milliseconds. The electronics may be an ultra low distortion and ultra low noise operational amplifier AD797 by Analog Devices, Inc. Curves 58 and 59 of the graph reveal the sensitivity of the detector and the electronics, respectively.

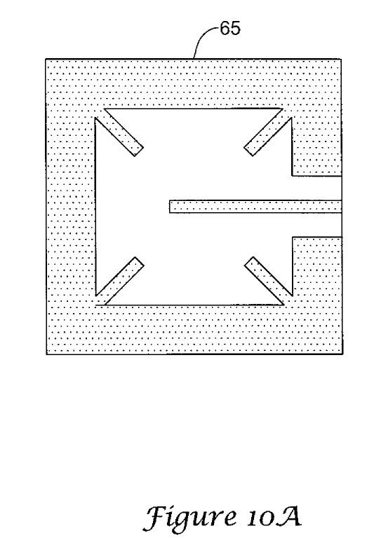

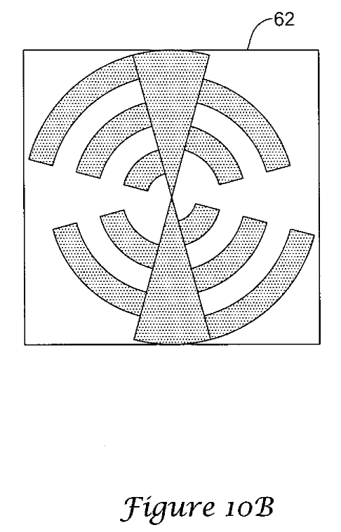

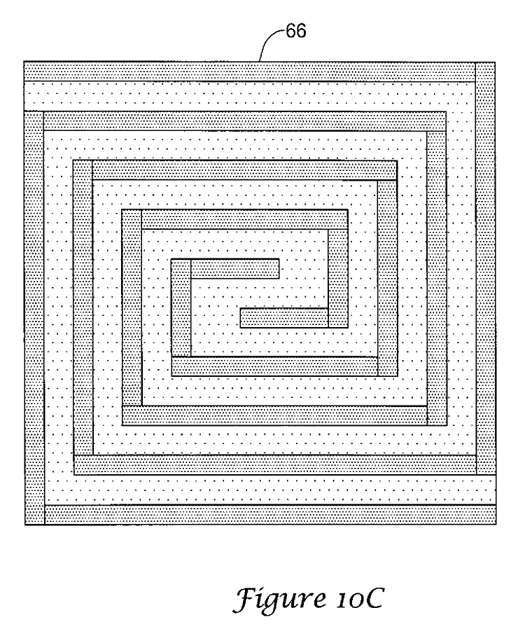

FIGS. 10a, 10b and 10c reveal other micro-antenna options, besides the micro-antenna 43 for detector 41 in FIGS. 5 and 6. Antenna type 65 is shown as a square slot with a simple, low risk detector coupling capability. It may have a gain of about 5±0.7 dB and a bandwidth of 1.5 to 2.5 THz. The polarization sensitivity of antenna type 65 may be regarded as independent.

Antenna type 62 is shown as a log periodic with a simple resistive coupling or a less simple capacitive coupling. It may have a gain of about 5±0.7 dB and a bandwidth of 1.3 to 2.7 THz. The polarization sensitivity of antenna type 62 may be regarded as dependent.

Antenna type 66 is shown as a spiral with a simple resistive or less simple capacitive coupling. It may have a gain of about 7±0.5 dB and a bandwidth of 0.5 to 3.0 THz. The polarization sensitivity of antenna type 66 may be regarded as independent.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A spectrographic system comprising:
a slit aperture
a dispersive element in an optical path from the slit aperture;
one or more detectors in an optical path from the dispersive element; and
optics as needed situated in the optical paths; and
wherein the one or more detectors comprise uncooled THz-sensitive sensors.

2. The system of claim 1, wherein the one or more detectors are arranged according to their optimal sensitivity in a spectral range of interest as defined by the dispersive range of the dispersive element.

3. The system of claim 1, wherein the one or more detectors comprise a thermally isolated microbridge sensor element.

4. The system of claim 1, wherein each of the one or more detectors comprises:
a micro antenna; and
a microbridge sensor coupled to the micro antenna.

5. The system of claim 4, wherein at least one size dimension of the micro antenna at least partially determines a wavelength to which the microbridge sensor is sensitive.

6. A dispersive spectrometer system comprising:
a dispersive element;
a mechanism for conveying incident radiation to the dispersive element; and
one or more detectors for sensing radiation from the dispersive element; and
wherein the radiation is in the THz range.

7. The system of claim 6, wherein:
the mechanism is for conveying the incident radiation to the dispersive element via a slit;
the one or more detectors form an array of detectors; and
each detector of the array of detectors comprises an uncooled sensor.

8. The system of claim 6, wherein:
the one or more detectors are arranged in an array according to a magnitude of wavelength at their optimal sensitivity; and
the one or more detectors comprise at least one uncooled sensor.

9. The system of claim 7, wherein the one or more sensors are situated proximate to the dispersive element so that radiation from the dispersive element is dispersed in manner directed according to wavelength to respective detectors optimally sensitive to that wavelength.

10. The system of claim 6, wherein:
the one or more detectors comprise:
an uncooled sensor; and
a micro antenna connected to the uncooled sensor; and
the sensor is a MEMS microbridge sensor;

11. The system of claim 8, further comprising:
processing electronics connected to the one or more detectors; and
wherein the processing electronics is for receiving THz detection signals from the one or more detectors and portraying information from the signals as absorbance versus frequency data.

12. The system of claim 11, wherein the processing electronics is further for identifying a material that has properties which correlate with the absorbance versus frequency data.

13. The system of claim 7, wherein the sensor is selected from a group consisting of a bolometer sensor, a thermoelectric sensor, a pyroelectric sensor, a ferroelectric sensor, and the like.

14. The system of claim 7, further comprising:
a THz radiation source for illuminating a target; and
wherein the mechanism for conveying incident radiation is for conveying radiation from a target as incident radiation.

15. The system of claim 14, wherein the THz radiation ranges from about 0.1 THz to about 10 THz.

16. A spectroscopic method comprising:
receiving THz radiation through a slit;
dispersing the radiation from the slit according to wavelength; and
selecting one or more detectors that have optimum sensitivity in a spectral range as defined by the dispersing the radiation according to wavelength; and
wherein the one or more detectors comprise an uncooled sensor.

17. The method of claim 16, further comprising placing the one or detectors so as to receive dispersed radiation in an optimal fashion according to the spectral range as defined by the dispersing the radiation according to wavelength.

18. The method of claim 17, further comprising receiving detection signals from the one or more detectors and portraying information from the signals as material identifying data.

19. The method of claim 18, further comprising:
converting the material identifying data into absorbance versus frequency data; and
identifying one or more materials that may have properties which correlate with the absorbance versus frequency data.

20. The method of claim 16, wherein the uncooled sensor is a microbridge sensor selected from a group consisting of a bolometer sensor, a thermoelectric sensor, a pyroelectric sensor, a ferroelectric sensor, and the like.
